(19) United States
(12) Patent Application Publication
(10) Pub. No.: US 2007/0005509 A1
(43) Pub. Date: Jan. 4, 2007

(54) Tax tracker transaction card

(75) Inventors: John C. Spiller, Austin, TX (US); Patrick Roney, Cedar Park, TX (US); Larry K. Wilkinson, Austin, TX (US)

Correspondence Address: John A. Fortkort, Suite 500, 9442 N. Capital of Texas Highway, Austin, TX, 78759, US

(73) Assignee: EBK, Inc.

(21) Appl. No.: 11/034,602

(22) Filed: Jan. 13, 2005

Related U.S. Application Data
(60) Provisional application No. 60/536,321, filed on Jan. 14, 2004.

(51) Int. Cl. G06Q 99/00

(52) U.S. Cl. 705/65

(57) ABSTRACT

A business arrangement is provided herein. In the arrangement, a first business entity (203) is provided which has a transaction card associated therewith that the first business entity manages. A contract is executed (207) between the first business entity and a second business entity (205). Under the terms of the contract, (a) the first business entity agrees to issue credit or debit cards to the second business entity and to manage the cards, (b) the second business entity agrees to pay the expenses incurred against the cards and to pay a management fee to the first entity, and (c) the second business entity further agrees that the cards shall be used solely for tax deductible business expenses.

### REFERENCE TO RELATED APPLICATIONS

This application claims priority from U.S. Provisional Application Ser. No. 60/536,321, filed on Jan. 14, 2004, and incorporated by reference herein in its entirety.

### FIELD OF THE DISCLOSURE

This application relates generally to expense tracking, and relates more specifically to methods for categorizing expenses charged against a transaction card

### BACKGROUND OF THE DISCLOSURE

In a typical business, a variety of expenses are incurred each day by the owners and employees of the business. These expenses may include such diverse items as car rentals, air plane tickets, meals, client entertainment, and office supplies. Some of these expenses may be tax deductible, while others may not be. Hence, for tax purposes, it is important not only to track these expenses, but also to separate those expenses which are tax deductible from those which are not. This process can be both time consuming and error prone, since the person separating the expenses will often have incomplete knowledge of the situation that gave rise to the expense. For example, it may be difficult to tell from a receipt or credit card statement whether a meal charged to a credit card was for business purposes or for personal enjoyment.

In an effort to reduce this burden, some credit card providers issue statements that provide a detailed breakdown of expenses that shows the date the expense was incurred, the vendor-or service provider, and the amount of the expense. Some credit card providers even categorize the expenses into specific expense categories. However, while such practices may reduce some of the effort involved in categorizing the expenses incurred by the employees and principals of a business, it does not provide any indication as to which expenses are tax deductible.

There is thus a need in the art for a system and method for tracking business expenses in a way that allows tax deductible expenses to be segregated from expenses that are not tax deductible, and that does so with minimal investment of man hours. There is further a need in the art for a simplified system and method for categorizing tax deductible expenses into their proper expense categories. These and other needs are met by the systems, methodologies, and software described herein.

### SUMMARY OF THE DISCLOSURE

It has now been found that the above noted needs can be met by a system and methodology (and by software which implements or facilitates such a system and methodology) which segregate business and personal expenses, and/or tax deductible and non-tax deductible expenditures, which are charged to a transaction card.

In one aspect, a method for doing business is provided herein. In accordance with the method, a first business entity is provided which has a transaction card associated therewith that the first business entity manages. A contract is executed between the first business entity and a second business entity. Under the terms of the contract, (a) the first business entity agrees to issue credit or debit cards to the second business entity and to manage the cards, (b) the second business entity agrees to pay the expenses incurred against the cards and to pay a management fee to the first entity, and (c) the second business entity further agrees that the cards shall be used solely for tax deductible business expenses. The business arrangement may further comprise a third business entity which provides financial services to the second business entity, wherein the third business entity has software associated therewith that (a) accesses digital receipts resulting from use of the transaction cards, and (b) utilizes information from those receipts to prepare financial documents for the second business entity. The software is preferably configured to access the digital receipts from a server associated with the first business entity.

In another aspect, a business arrangement is provided, which comprises first and second business entities, and a contract between the first and second business entities. The first business entity has a transaction card associated therewith that the first business entity manages. Under the terms of the contract, (a) the first business entity agrees to issue credit or debit cards to the second business entity and to manage the cards, (b) the second business entity agrees to pay the expenses incurred against the cards and to pay a management fee to the first entity, and (c) the second business entity further agrees that the cards shall be used solely for tax deductible business expenses.

In still another aspect, a system for processing a transaction card is provided. The system comprises (a) a transaction card associated with a cardholder; and (b) a plurality of terminals, each of the terminals being adapted to process a sale utilizing the transaction card, and being further adapted to allow the cardholder to enter an expense code associated with the sale, wherein the expense code identifies a tax category that the expense is associated with.

In yet another aspect, a method for categorizing expenses charged against an account is provided. The method comprises the steps of (a) receiving, from a purchaser, account information identifying an account against which the expense of goods or services being purchased is to be debited; and (b) receiving, from the purchaser, an expense code which identifies a tax category that the expense is associated with.

In a further aspect, a method for associating a transaction card transaction with an expense account is provided. In accordance with the method, transaction request information is received from a cardholder via a remote terminal, wherein the request includes a number associated with an expense account in addition to account authorization. The transaction request information and number is then processed to associate the transaction with the expense account.

These and other aspects of the present disclosure are described in greater detail below with respect to the systems, methodologies, and software described herein.

### BRIEF DESCRIPTION OF THE DRAWINGS

For a more complete understanding of the systems, methodologies, and software described herein and the advantages thereof, reference is now made to the following description taken in conjunction with the accompanying drawings in which like reference numerals indicate like features and wherein:

FIG. 1 is a flowchart illustrating one possible, non-limiting embodiment of the methodology disclosed herein;

FIG. 2 is a schematic diagram of one possible, non-limiting embodiment of a business arrangement in accordance with the teachings herein;

FIG. 3 is a diagram illustrating one possible, non-limiting embodiment of the job costing feature (or EAIN) disclosed herein;

FIG. 4 is an illustration of a system for implementing the methodologies described herein; and

FIG. 5 is an illustration of a system for implementing the methodologies described herein.

### DETAILED DESCRIPTION

As used herein, the term “transaction card” refers to a device (whether or not it is “card” shaped) that is used to charge purchases to an account, and includes such devices as credit cards, debit cards, stored value cards (both rechargeable and non-rechargeable), and smart cards.

As used herein, the term “Expense Account Identification Number” (EAIN) refers to any device, code, number, letter, symbol, digital certificate, smart chip, digital signal, analog signal, biometric or other identifier/indicia suitably configured to identify one or more expense accounts that a transaction is associated with.

As used herein, the term “Processing Network” refers to a network over which, inter alia, debit, credit, charge and/or other transactions are conducted and to which are connected one or more account information input devices (e.g., card readers) and one or more credit and/or debit card institutions. Examples include Interlink, VISA, MasterCard, and American Express. The term “Processing Network” should be understood to include any network which facilitates any type of transaction.

As used herein, the term “Card Reader” refers to any device which is configured to read debit, credit, charge or other transaction cards, which interfaces to a card processing network, and which may be equipped with a PIN entry keypad. The term also includes any other computerized device configured to receive any form of a transaction card number.

As used herein, the term “Charge Card” refers to any financial instrument that supports substantially real-time, network mediated, currency transfers, typically in support of the purchase of services and products at the POS.

As used herein, the term “Charge Servicer” refers to a transaction servicer that supports charge card transactions.

As used herein, the term “Credit Card” refers to any financial instrument that supports network mediated currency transfers, typically in support of the purchase of services and products at the POS, and for which there is an associated delay in transfer, and discount rate charged to the SE.

As used herein, the term “Credit Servicer” refers to any transaction servicer that supports credit card transactions.

As used herein, the term “Debit Card” refers to any financial instrument that supports substantially real-time, network mediated currency transfers, typically in support of the purchase of services and products at the POS, and for which there is a transaction fee.

As used herein, the term “Debit Gateway” refers to any system that attaches to a proprietary network and system as well as a card processing network, and which conducts transactions in a way similar to a debit card reader, except that the card is not generally present, and the card information originates from the proprietary network and system.

As used herein, the term “Debit Servicer” includes any transaction servicer that supports debit card transactions.

As used herein, the term “Internal Network” refers to any proprietary network within an institution, over which transactions may be routed, as in the routing of a transaction between a transaction system and a transaction servicer, payment gateway, and/or debit gateway.

As used herein, the term “Payment Gateway” refers to any system that attaches to a proprietary network and system, as well as a card processing network, and which conducts transactions in a manner similar to a card reader, except that the card is not present and the card information originates from the proprietary network and system.

As used herein, the term “POS” refers to the general location where the sale or other transaction takes place.

As used herein, the term “Card Provider” refers to any entity that offers the transaction card service and/or card to consumers by use of a transaction card Transaction Processor, which may be used in combination with other internal transaction systems.

As used herein, the term “Merchant Establishment” (ME) refers to any service establishment, such as a product or service retailer or merchant, that accepts a debit, credit, charge or other transaction card.

As used herein, the term “Card Number” refers to any device, code, number, letter, symbol, digital certificate, smart chip, digital signal, analog signal, biometric or other identifier/indicia suitably configured to allow the consumer to interact or communicate with the system, such as, for example, account number authorization/access code, personal identification number (PIN), Internet code, other identification code, and/or the like which is optionally located on a rewards card, charge card, credit card, debit card, prepaid card, telephone card, smart card, magnetic stripe card, bar code card, transponder, radio frequency card and/or the like. The card number may be distributed and stored in any form of plastic, electronic, magnetic, radio frequency, wireless, audio and/or optical device capable of transmitting or downloading data from itself to a second device. A card number may be, for example, a fifteen- or sixteen-digit credit card number. Each company's credit card numbers comply with that company's standardized format such that the company using a sixteen-digit format will generally use four spaced sets of numbers, as represented by the number “#### #### ####”. The first five to seven digits are reserved for processing purposes and identify the issuing bank, card type and the like. In this example, the last sixteenth digit is used as a sum check for the sixteen-digit number. The intermediary eight-to-ten digits are used to uniquely identify the customer.

Systems and methodologies are provided herein (as is software which implements or facilitates these systems and methodologies) which segregate business and personal expenses, and/or tax deductible and non-tax deductible expenditures, which are charged to a transaction card. For purposes of illustration, the systems, methodologies and software will be described herein with reference to particular embodiments. However, one skilled in the art will appreciate that various substitutions and modifications can be made to these systems, methodologies and software without departing from the scope of the teachings herein.

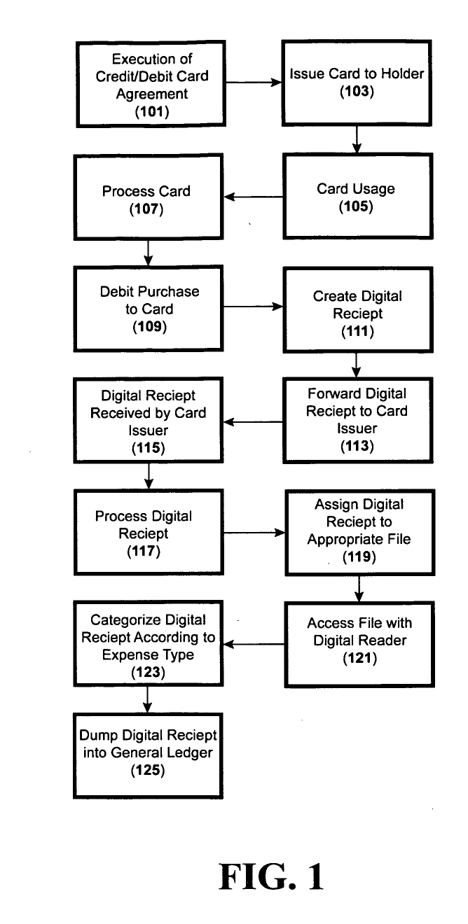

FIG. 1 illustrates one particular, non-limiting embodiment of the methodology disclosed herein. In the method depicted in FIG. 1, a transaction card is issued 103 to an employee of a corporation for use in paying business expenses. Prior to or concurrent with the issuance of the card, the employee signs an agreement 101 with the corporation and/or the card issuer, under the terms of which the employee agrees to use the card solely for business purposes.

The card issued to the employee preferably carries a predetermined balance or credit limit. The balance or credit limit on the card may be determined by such considerations as the position of the employee within the corporation, the length of time the employee has worked for the corporation, the anticipated business expenditures for a given period of time, the creditworthiness of the employee and/or the corporation, and other such considerations. The card may carry the name and/or logo of the card issuer or the corporation, or it may be co-branded (that is, it may carry the name and/or logo of both the card issuer and the corporation). It may also carry such features as appear on conventional credit, debit or check cards, including, but not limited to, security features (e.g., signature blocks, authenticity holograms, and the like), magnetic strips, and alphanumeric data, the later of which may include such information as the card number and/or expiration date.

At the Point of Sale (POS), the employee presents the card 105 to a vendor or merchant. The vendor or merchant then processes the card 107 so that the amount of the purchase will be debited to the card 109 and the balance or available credit limit on the card will be reduced accordingly.

The step of processing the card may include, but is not limited to, such steps as swiping the card through a magnetic reader, presenting the card to an Optical Character Recognition (OCR) device, or manually entering the number and other required information (e.g., the card expiration date, if any) associated with the card. Preferably, it also includes the steps of creating a digital receipt 111 and forwarding the digital receipt 113 to the card issuer (the later of which may be, for example, a bank or financial institution) and/or the employee's corporation.

The digital receipt will contain information relating to the purchase. Such information may include, but is not limited to, the date of the purchase, the amount of the purchase, the name, tax I.D. or other identification of the vendor or provider of the goods or services being purchased, and a listing of the goods or services purchased (possibly including a product or service description and any relevant product or service codes).

The step of debiting the balance or credit limit associated with the card may include various other steps. These other steps may include, for example, performing various arithmetic operations, and reading from and/or writing to one or more memory devices or locations on the card. In some embodiments, a copy of the digital receipt of the transaction may also be recorded on the card.

After the digital receipt has been forwarded to the card issuer, it is received by the card issuer 115 and is processed 117. The step of processing the digital receipt may include, but is not limited to, the steps of assigning the receipt 119 to one or more files associated with a particular business entity or account associated with the card.

After the card issuer has processed the receipt, the file (or files) into which the digital receipt is placed is accessed by a digital reader 121. The digital reader is preferably a software program which categorizes 123 the digital receipts according to expense type and dumps 125 either the digital receipt, or pertinent information taken from the digital receipt, into the general ledger of the client corporation. The digital reader may be adapted to access the files into which a digital receipt is placed on a periodic basis (e.g., daily, weekly, monthly, or at the end of every business quarter). Alternatively, the digital reader may be adapted to receive a message from the card issuer each time one or more new digital receipts have been received by the card issuer, and may further be adapted to access the appropriate files and to record or download the new information at that time or at a specified interval thereafter.

Preferably, the digital reader is a software program that operates on a server and accesses the relevant files of the card issuer remotely. In such embodiments, the server is preferably maintained by a financial services provider which provides accounting or other financial services to the corporation. The card issuer will preferably have a contract or agreement with the financial services provider whereby the card issuer agrees to make the relevant files accessible to the financial services provider. The contract will preferably specify the terms of access, such as limitations on use the data accessed. The financial services provider will also typically have a contract or agreement with the corporation whereby the financial services provider agrees to maintain some or all of the expense records associated with the corporation. If the digital reader is operating on a server maintained by the financial services provider, it may be in communication with the files maintained by the card issuer (or a server upon which those files reside) by a dedicated line, over the Internet, or by other suitable means.

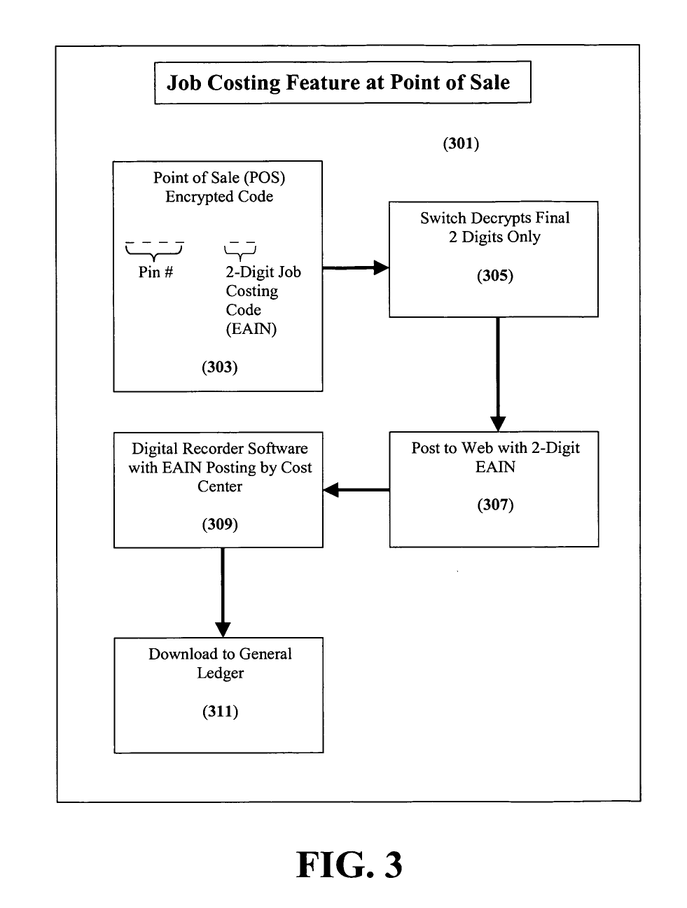

In some embodiments of the methodologies described herein, a job costing feature (referred to herein as an expense account identification number (EAIN)) may be provided. One possible embodiment of such a feature 301 is illustrated in FIG. 3. As shown therein, at the Point of Sale (POS) (e.g., when the transaction card is swiped to initiate the purchase), a transaction code is entered 303. The transaction code includes any required Personal Identification Number (PIN) as may be required, plus an EAIN. The EAIN is typically a series of characters (preferably alphanumeric characters, and more preferably digits) that associates the transaction cost with a particular cost center or location within the client corporation. The number of characters in the EAIN is not particularly limited, but is preferably two.

The EAIN is then embedded into the transaction, and may subsequently appear on hard and/or soft copies of the transaction card statement. The details of the transaction (which typically include such information as the transaction date, vendor name, amount of the transaction, and SIC code), as well as the PIN and EAIN, are then passed to a switch associated with a bank or other financial institution, where the EAIN is decrypted 305. The transaction information, including the EAIN (but typically not including the PIN and SIC code), is then posted 307 to a server (and preferably, to a web site hosted on the server) associated with the financial institution and accessible by the digital reader software. The digital reader software then accesses the transaction information and utilizes the EAIN to process 309 the information. Typically, the step of processing the information will include the steps of assigning the information to a general ledger account code and cost center within the client corporation. The digital reader then downloads the processed information 311 to the appropriate portions of the general ledger of the client corporation.

In some embodiments, the digital reader may be installed on one or more computers or operating systems associated with the card issuer. In such embodiments, the digital reader acts, as above, to categorize the digital receipts according to expense type. The resulting categorized receipts, or files derived therefrom, may then be forwarded to the client corporation and/or to the financial services provider, for any further processing that may be required to add the expenses to the general ledger of the client corporation.

In some variations of the methodologies described above, the transaction card may be used for purposes other than business expenses. For example, a transaction card may be issued to employees of a corporation in lieu of a paycheck. The employees may then use the transaction card like a normal credit card and may record expenditures of any type against the card up to the amount recorded on the card.

In certain embodiments of the methodologies described herein, the card is adapted for use for both business and personal expenses, but the user is provided with a means to designate, at the time of purchase, whether or not the expense is a business expense and/or is tax deductible. Various means may be provided for this purpose. For example, in some embodiments, the card reader may be adapted to query the user as to whether the expense is a business expense and/or is tax deductible, and the user may indicate his selection through appropriate keyboard entry, by touching a designated portion of a screen or display with a finger or stylus, or by other such means.

In other embodiments, the card itself may be provided with a means to indicate whether the expense is to be considered a business expense and/or is tax deductible. For example, the card may be provided with a pressure sensitive tab that the user can press to toggle between a business expense designation and a personal use designation. In one specific example of such an embodiment, the card may be provided with a display (LCD or otherwise) that indicates the present setting on the card and/or other pertinent information, such as the code associated with a transaction. For example, the card may be provided with a logo or holographic image that changes color depending on the designation made by the user, or it may be provided with a holographic image (e.g., a B for business expense or a P for personal expense) that indicates the current setting on the card.

In the preferred embodiment, the designation associated with an expense is made at the point of sale, and may occur by default (e.g., the fact that a person is using the card for an expense may be taken as an indication that the expense is a tax deductible and/or business expense). However, in some embodiments of the methodologies disclosed herein, this designation may be made at a later point of time.

For example, the card issuer or credit card company may send periodic statements of expenses, and the card holder may be required to indicate which of those expenses is a business expense and/or is tax deductible. Thus, in some embodiments, the statements may be sent electronically, and the card holder may be provided with software that processes the statements and queries the user as to the proper category for each expense. Such software may include a tax tutorial which is available if the categorization of an expense is unclear to the card holder. The tutorial may include, for example, a series of questions that the card holder is requested to answer, the answers to which lead to an appropriate conclusion on the matter. The software may also be adapted to output the results of a session to appropriate tax preparation software. The software may be loaded on a computer associated with the card holder, or may be accessible remotely by the card holder as, for example, over the Internet.

In other embodiments, the card holder may be sent a reminder periodically (e.g., monthly or quarterly) that elections must be made as to which of the expenses recorded or incurred in a recent period are business expenses and/or are tax deductible. The reminder may be sent electronically, as by email, and may include a link to a website. When the cardholder selects the link, he is directed to the website, where he makes an appropriate election for each expense in question (or, as the case may be, for a given portion of the expense). The website may be equipped with software that processes the statements and queries the user as to the proper category for each expense, and this software may include a tax tutorial of the type noted above. In some embodiments, the software may be adapted to place any expenses that the cardholder is unsure of the proper election for into a separate file, and an election may be made for these expenses at a later point in time.

Alternatively, the card may have one or more memory devices associated with it, and preferably incorporated into the card, which record expenses charged to the card. A card reader, which may be adapted to interface with a PC or other computer, may be made available to the card holder which allows the card holder to copy or download the transactions recorded on the card and to categorize them appropriately. For example, the reader may include software of the type noted above that processes the statements and queries the user as to the proper category for each expense. Also as noted above, this software may include a tax tutorial which is available if the categorization of an expense is unclear to the card holder.

In the various embodiments of the methodologies and systems disclosed herein, one or more web sites may be provided that are associated with the card. Such a web site (which may be the same as, or different from, the web site noted above) may provide card usage information, including, but not limited to, such information as a detailed listing of the current charges on the card, the available credit on the card, and the like. The web site may also include tax assistance software to guide the card user or card holder in allocating expenses, determining what portion of an expense is tax deductible, identifying expenses that are likely to trigger an audit, and the like.

In some embodiments, the web site may have various features that can be tailored to a particular user or profession. For example, in some embodiments, the web site may have a point and click menu where every profession is listed and those beneficial tax deductions and credits associated with a particular profession can be present for informative purposes. As previously noted, the web site may include one or more tutorials designed to educate the user of the card as to what types of expenses are tax deductible based upon IRS rules and regulation.

In variations of these embodiments, the user or cardholder may be asked to fill out a questionnaire at the time that an account is opened for that user or cardholder and, based on the information provided in the questionnaire, the user or cardholder's profession may be determined. This information may also be used to determine various characteristics of the user or cardholder's business. Based on this information, the various features on the website that are made available to the user or cardholder may be tailored to the cardholder or user's business.

In some embodiments of the systems and methodologies disclosed herein, one or more of the EAINs input by the cardholder may have limits associated with them. These limits may be, for example, predefined limits which remain fixed for a period of time. If, at any time, the cardholder attempts to assign an expense to an EAIN such that the total of the expenses assigned to that EAIN for a given period exceeds a given limit, the transaction card will be declined. In some such embodiments, the cardholder may be given the option to assign the transaction to a different EAIN, while in other embodiments, reactivation of the card may be required before it can be used again.

In other embodiments of the systems and methodologies disclosed herein, the cardholder is required to enter a PIN number or other security code to enable processing of the transaction. Once a valid code is properly entered, the user is given the opportunity to enter an alphanumeric message which is embedded in the digital receipt generated during the transaction. The message may be of any given length, and may include detailed information relating to the transaction, such as identification of a client that the transaction is to be associated with, persons in attendance when the transaction was made, and the like. This information may be input on a keyboard, monitor or other input device associated with a card reader. For example, the cardholder may use a stylus to write a hand-written note on a monitor associated with the card reader.

This information may also be input on a device that is in communication with the card reader. For example, in one particular embodiment, after the cardholder enters an appropriate PIN, a line of communication is open between the card reader and an external device associated with the cardholder. The external device may be, for example, a personal digital assistant, a cell phone, or a lap top. The cardholder then uses the external device to input an alphanumerical message which is to be associated with the transaction. The message may be, for example, an electronic expense form which is filled out by the user on the external device and which is subsequently transmitted to the card reader, which embeds the message in the digital receipt. The embedded message may then be accessed later for appropriate categorization of the expense (or expenses) that were the subject of the transaction.

The systems and methodologies described herein may be used with various biometrics for improved security. Such biometrics include, but are not limited to, fingerprinting, retinal scans, voice recognition, and the like. In some embodiments, suitable biometrics may be used in place of all or part of a PIN, and the digits currently used for a PIN may be used instead for tax tracking purposes.

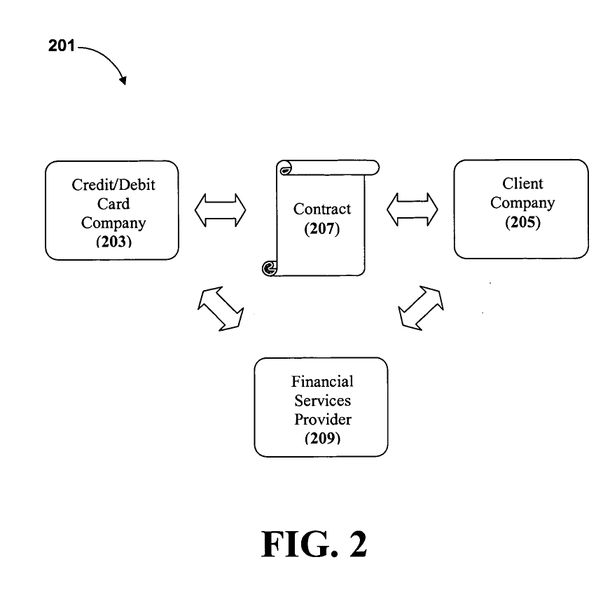

The above noted methodologies may be leveraged in a variety of business arrangements. One such possible arrangement is depicted in FIG. 2. In the business arrangement 201 shown therein, a first business entity 203 exists which has a credit and/or debit card associated therewith, and a second business entity exists which is a client of the first business entity. The first and second businesses have a contract 207 executed between them, under the terms of which (a) the first business entity agrees to issue transaction cards to the second business entity and to manage the cards, (b) the second business entity agrees to pay the expenses incurred against the cards and to pay a management fee to the first business entity, and (c) the second business entity further agrees that the cards shall be used solely for tax deductible business expenses.

The second business entity is preferably also a client of a financial services provider 209. The financial services provider is typically a company or organization involved in providing accounting services to the second business entity, but could also be engaged in providing other types of financial services. The financial services provider has a digital reader associated therewith (see FIG. 1) that accesses the electronic receipts of charges made to the transaction card. As noted above, those receipts will typically be stored on a server associated with the first business entity. The digital reader categorizes the digital receipts according to expense type and dumps either the digital receipt, or pertinent information taken from the digital receipt, into the general ledger of the client corporation.

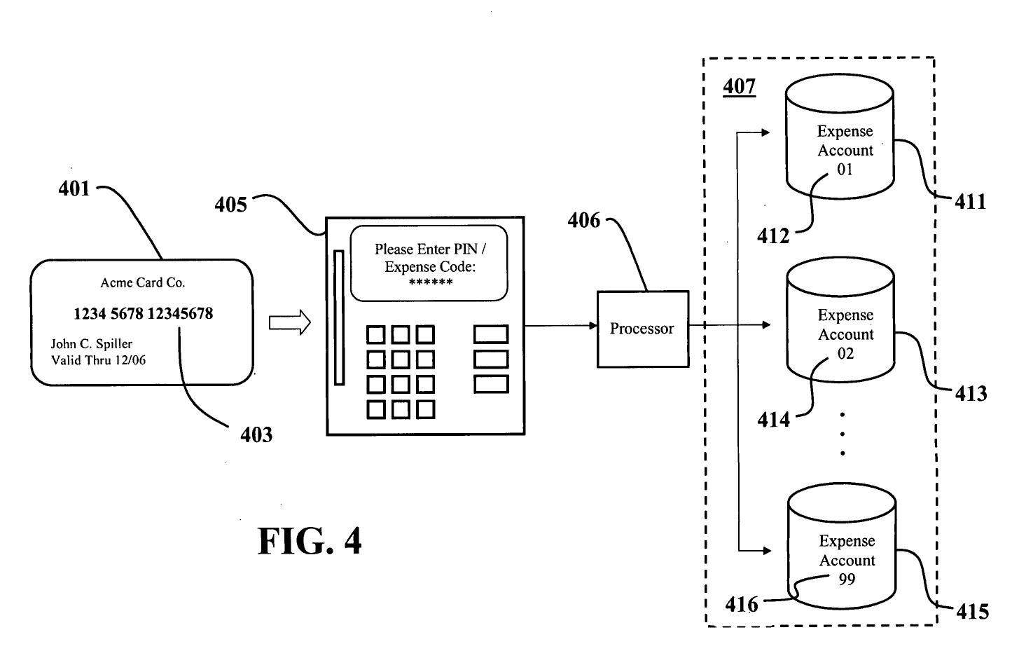

One particular, non-limiting embodiment of s system that may be used to implement the methodologies disclosed herein is depicted in FIG. 4. The system disclosed therein utilizes a transaction card 401 which has a transaction card number 403 embossed thereon. The transaction card 401 is configured to communicate with a card reader 405, which may be a point of sale (POS) device, an ATM, or another computerized device or terminal. The card reader 405 is configured to read the transaction card number 403 and to transmit it through a card processing network 406 to a transaction card provider 407. In some embodiments, the card reader 405 may be further configured to allow a transaction card number to be entered without the use of a physical card, as might be the case, for example, if the transaction card is used to place an order telephonically or over the Internet.

The cardholder will typically have access to multiple expense accounts 411, 413 and 415 which are associated with the cardholder, with an organization that the cardholder is affiliated with (e.g., the cardholder's employer), or with the card itself, and to which individual transactions made using the card may be assigned. These expense accounts may vary from one cardholder or organization to another, and may be tailored to the particular industry that the cardholder or organization does business in. However, the expense accounts will typically be defined to facilitate accounting services and/or the preparation of tax documents, including tax returns. Each of these expense accounts will typically be associated with a unique expense account identification number (EAIN) 412, 414, 416. Examples of possible expense accounts include “travel”, “recruiting”, “marketing”, and “taxes”. Each of these expense accounts may have one or more sub-accounts associated therewith, and each account or sub-account may be assigned a unique EAIN. TABLE 1 depicts an example of some accounts and sub-accounts and their associated EAINs.

TABLE 1
Exemplary Expense Account Identification Numbers

| EAIN | ACCOUNT NAME |
|---|---|
| 01 | Travel |
| 02 | Transportation |
| 03 | Lodging |
| 04 | Meals |
| 05 | Entertainment |
| 06 | Tickets/Fares |
| 07 | Taxes |
| 08 | Federal |
| 09 | State |
| 10 | Local |
| 11 | Property |
| 12 | Use |

In a typical embodiment, at the time the transaction is consummated, the cardholder swipes the transaction card 401 through the card reader 405. The card reader 405 reads the transaction card number 403, recognizes the transaction card 401, and prompts the cardholder for a PIN and/or an EAIN to be associated with the transaction. The cardholder enters the appropriate EAIN (in the embodiment depicted, a two-digit number within the range 01 to 99) corresponding to the expense account to which cardholder desires the transaction to be appropriated to. The process of entering the EAIN may include such steps as entering a number into a keypad, selecting an icon or button corresponding to the EAIN, swiping magnetic stripes (or scanning bar codes, characters, or other such designators) located on different portions of the card that correspond to different EAINs, providing a specific biometric to activate a particular EAIN, and/or any other means or method for inputting the EAIN number into the system, including various combinations or sub-combinations of the foregoing. For example, as shown in the embodiment depicted in FIG. 4, if the cardholder desired to assign a transaction to expense account 411, the cardholder would enter “01” as the EAIN.

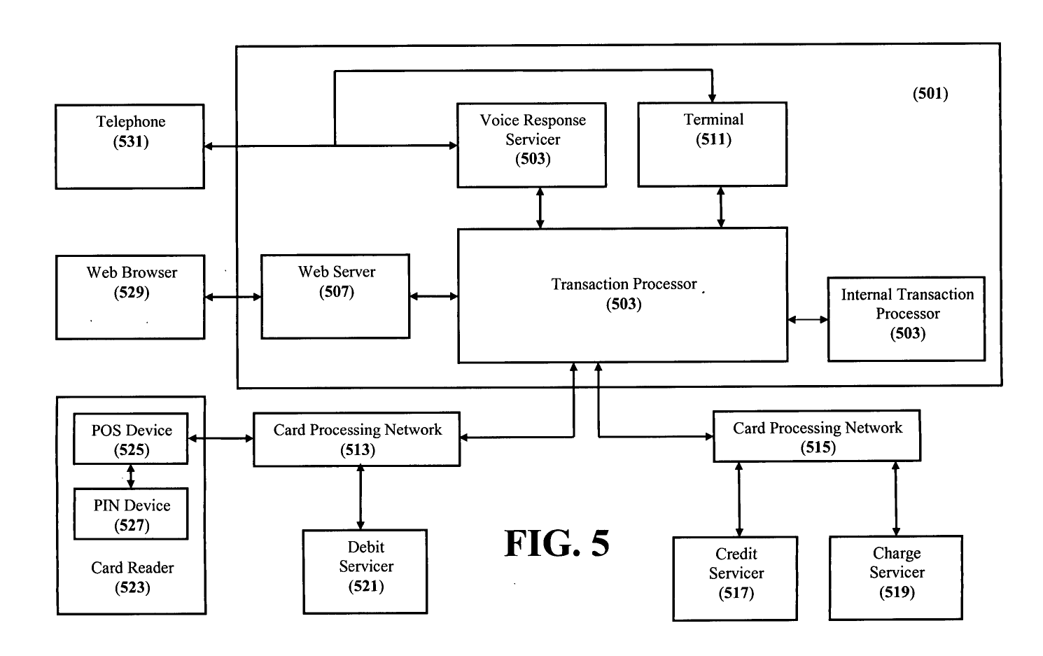

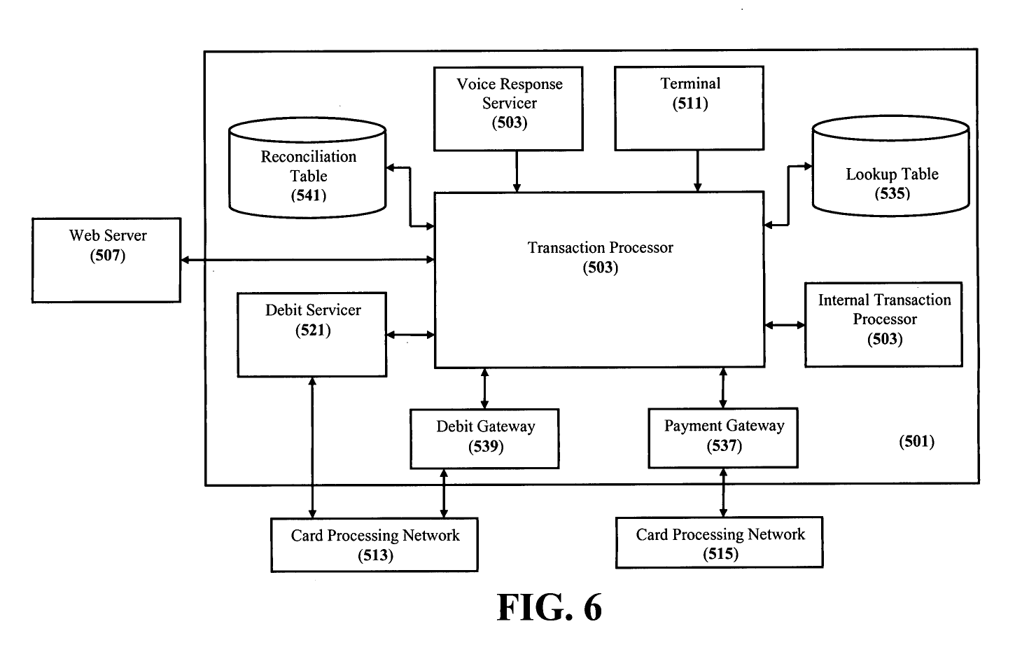

FIG. 5 depicts one specific, non-limiting embodiment of a system and network configuration that may be used in the implementation of the methodologies described herein. The particular system depicted includes a transaction card provider 501 that has associated therewith a transaction card transaction processor 503, an internal transaction processor 505, and a plurality of user interface systems, including a web server 507, a voice response servicer 509, and a customer service terminal 511. The system further includes card processing networks 513, 515, a credit servicer 517, a charge servicer 519, a debit servicer 521, and the like. On the consumer interface end, the system also includes a plurality of card readers 523, each of which preferably includes a POS device 525 and/or a PIN device 527.

In some embodiments, the cardholder may associate various expense accounts with the card number online. This may be accomplished, for example, through the use of a web browser 529 which is connected to a web server 507 maintained by the transaction card provider 501. The web server 507 may provide forms for maintenance of transaction card associations (including expense accounts, EAINs, and/or PIN numbers associated with the card). A telephone line 531 may also be maintained by the transaction card provider 501, which line is connected to a voice response unit 509 that is capable of decoding spoken or DTMF touchpad tones that the cardholder enters in response to questions that support the maintenance of transaction card associations. This functionality may also be provided by a terminal 511, such as a computer workstation, or any other type of input/output device with which a transaction card provider service representative can perform maintenance of transaction card associations. Such maintenance may be provided in response to verbal or written correspondence with the cardholder, as might occur over the telephone at an inbound call processing center. Various combinations and sub-combinations of the foregoing elements (and like elements) may be used to create, maintain, modify, and/or delete associations.

In the particular embodiment depicted in FIG. 5, appropriate gateways have been provided to communicate with external transaction servicers via card processing networks 513, 515 to service, for example debit, charge, or credit card accounts that have expense accounts associated with them. Additionally, an internal transaction processor 505 may be provided, wherein the internal processor 505 is part of the transaction card provider system and is configured to process card transactions internally.

In one embodiment, as shown in FIG. 5, the system comprises a lookup table 535 which may be pre-loaded with information about transaction card accounts and the expense accounts and/or EAINs associated with them. This information may have been previously provided, for example, during enrollment, and may have been modified as described above. The system may also store cardholder specific information that was provided during enrollment, or which was obtained from other sources. Such cardholder specific information may include, for example, the cardholder's name, address, phone number, transaction card number, expense account information, and activation information. This information may be stored in a cardholder information table. The system may also store transaction details, which would be initialized during enrollment to contain no transaction records. This information is stored in a transaction record table.

After the cardholder receives the transaction card, activation may be desired before use of the card is permitted. Activation may be facilitated by any number of suitable means, including, for example, calling a cardholder service representative, calling a voice or touch-tone response system, accessing a web site, or any other suitable means effective in providing information about the card and/or cardholder so that the transaction card provider has reasonable certainty that the card was received by the intended cardholder. In one non-limiting embodiment, the cardholder calls from their home or business phone number of record, providing an activation code or account number that was delivered with the transaction card in the mail, possibly in combination with other identifying information, such as social security number, driver's license number, or the like. The activation mechanism may also obtain information not provided directly by the cardholder by utilizing a communication device used by the cardholder for activation. For example, the activation mechanism may obtain further information from a telephone caller ID or Internet TCP/IP routing or address. After activation, the cardholder may proceed to the steps of card use and/or association of accounts.

Cardholders who are provided with a transaction card may also be provided with authentication credentials for identity verification during subsequent processes such as adding, editing, or deleting associations, or terminating the card or account. In an exemplary system, the enrolled cardholder is given an ID and password to be used upon subsequent access to the transaction card web site in order to gain access to screens that support transaction card processes. In an alternative embodiment, the cardholder may be prompted to select a password, or answer a secret question, where this information can be used during any or all of the mechanisms for providing information and requesting processes.

The cardholder communicates information to the transaction card processor 533 (see FIG. 5) through one or more of a variety of mechanisms such as submission of an on-line form, mail of a paper form, telephone conversation with cardholder service representative, or telephone interaction with a voice or touch-tone response unit. The cardholder may be required to provide authentication credentials before proceeding with this process, or certain steps thereof. In an exemplary embodiment, if the cardholder accesses and logs into a web site, an ID and password may be required, or an ID and password may be provided for subsequent use at the site (for example, for creating associations between a transaction card and expense accounts). The information provided by the cardholder generally includes the account number of the transaction account to be associated and an EAIN number, and may also include other information such as the name, expiration date, billing address, and other identifying information associated with the particular transaction account.

This information is processed by processor 533 (see FIG. 5) to ensure validity and support for the desired transaction account. If supported, then processor 533 adds an association record to the lookup table 535. Preferably, lookup table 535 is a relational database. However, it may also be any suitable storage system that resides in computer memory, disk storage, or the like, and which optionally includes a database application service that is invoked by database access APIs which might comply with an established standard data access protocol such as SQL. The association record includes some or all of the information provided by the cardholder and may optionally include additional information that is obtained from other sources. In one embodiment, the association record stores EAINs, selection card numbers and/or account numbers associated with a transaction account.

As previously noted, the system will typically be provided with a means for allowing the cardholder to create a new association of an expense account to the transaction card for which the cardholder has enrolled and which has been received. In one embodiment, for example, the cardholder logs on as described above and is authenticated. The cardholder, upon entering a transaction card number, is given the option to add an association, after which the cardholder may be queried for additional information about the expense account to be added and/or the transaction card that the expense account is to be associated with. Upon entering the desired expense account and a suitable EAIN, the transaction card is then suitably configured to allow expenses to be allocated to the specified expense account, wherein the EAIN number is the number associated with the added account. The transaction card transaction processor look-up table 535 (see FIG. 5) maintains the expense account associations.

As previously noted, the system will also typically be provided with a means for editing an existing association between an expense account and a transaction card. The cardholder communicates information to the transaction card processor 533 through one or more of a variety of mechanisms as described above. The information that the cardholder communicates includes changes to existing information in the lookup table 535. For example, the cardholder may change the EAIN of an expense account associated with a transaction card. The processor 533 may optionally validate the new information that has been provided.

As previously noted, the system will also typically be provided with a means for removing an existing association of an expense account with a transaction card for which the cardholder has enrolled and which has been received. The cardholder may communicate information to the transaction card processor 533 through one or more of a variety of mechanisms as described above. The information that the cardholder communicates generally includes some identification of the association to be removed, e.g., the associated EAIN.

In some embodiments, the system described herein is provided with a means to allow the cardholder (or other authorized party) to terminate transaction card privileges. A cancellation request may be communicated from the cardholder to the transaction card provider by any suitable means, such as cardholder service call, VR call, web site interaction, or the like. Alternatively, termination may be initiated by the transaction card provider for a variety of reasons, such as fraudulent activity, non-payment, or the like. Enrollment data will be updated to reflect the termination of the transaction card account or termination or removal of a particular transaction account or EAIN. As such, the cardholder is no longer able to use the transaction card and/or to allocate expenses to the EAIN. Transactions which attempt to allocate expenses to an invalid EAIN will be considered invalid by the transaction card transaction processor, and any cancelled or deactivated card will be denied at the POS.

After a cardholder has successfully enrolled and received a transaction card with a transaction card number, and after at least one association has been added or has been previously established, the cardholder may use the card for a transaction to purchase goods or services or to conduct any number of other transactions. To use the transaction card, the cardholder initiates a transaction (that is, the cardholder purchases goods or services at a service establishment) and proceeds to use the transaction card in the standard way in which the service establishment accepts PIN-based debit card transactions. Typically, the service establishment will have previously established a relationship with a card processing network 513, obtained a card reader 523, established an account with a financial institution for receipt of payments, and properly set up and configured the card reader 523, account information for the service establishment, and/or other optional POS equipment 525 such as a cash register. The amount of the purchase, plus optional additional information such as identification of the product or service, and merchant information, are also generally communicated to the POS device 525. This may occur automatically via an interface to another POS device such as cash register, or may be performed manually by the service establishment.

In one embodiment, to complete a transaction, a representative of the service establishment or the cardholder swipes the transaction card through the POS device 525 of a card reader 523. Alternatively, the transaction card may be a smart card device which is placed into a smart card reader, or else the transaction card number may be manually entered into POS device 525 by the service establishment. Additional embodiments contemplate situations where no physical cards are present; rather, only the transaction card number is used. These situations involve online transactions or other so called “card not present” transactions. If the card reader 523 is not a debit card reader, then the POS device 525 optionally prompts the user to identify whether the card is a debit or charge card. In some embodiments, this procedure includes reading an alphanumeric display and pushing an appropriately labeled button on PIN device 527. POS device 525 and PIN device 527 may be distinct or the same, and may be contained in any number of physical devices which may be interconnected appropriately by hard-wired or wireless connections, or through other communications links or physical connections for the exchange of information or power.

POS device 525 also prompts the user to enter an EAIN. Using PIN device 527, the cardholder enters the EAIN of a previously created expense account associated with the transaction card and to which the cardholder wishes the expense of the transaction to be allocated. POS device 525 then establishes the necessary network connection to card processing network 513, which may require analog telephone dial up, exchange of authentication information, communication protocol handshaking, encryption, and other such steps. For example, card processing network 513 may be Interlink, or a proprietary network maintained by a third party that can access other networks such as Interlink. POS device 525 may use information, such as the selection of the transaction card type (e.g., “debit card”) and/or the card number, to send information to the correct processing network.

Once the connection from POS device 525 to card processing network 513 is established, the POS device 525 communicates the necessary transaction request information to the card processing network 513 in the appropriately encrypted format. This information generally includes identification of the transaction card (such as the transaction card number, expiration date, and the like), the EAIN entered by the cardholder, and currency amount of the transaction being requested. The service establishment is also identified in the transaction, where the service establishment identifying information may be established during the initial connection and/or during the communication of the transaction request information. Additional information may optionally be included in the communication, such as a reference code that identifies this specific transaction between the cardholder and the service establishment.

Through the card processing network 513 and POS device 525, the transaction request is delivered to the transaction card provider 501 in response to the transaction card number. In one non-limiting embodiment, recognition of the transaction card provider is facilitated by a bank identification number (BIN) or another set of digits which are configured to identify the transaction card provider. In such an embodiment, the first 6 digits direct the routing to the appropriate card institution. As shown in FIG. 5, the transaction card transaction processor 503 receives this request, which is processed by debit servicer 521. The transaction card provider performs primary authorization, which is the authorization needed in order for the merchant to accept the transaction card payment instrument. In the exemplary embodiment shown in FIG. 5, it should be noted that the debit servicer 521 is internal to the transaction card transaction processor 501, whereas in FIG. 5, debit servicer 521 is external to the transaction card provider 501. In FIG. 5, debit servicer 521 services requests from the transaction card provider 501 and re-routes the requests externally after generating a new (or secondary) transaction request with the underlying (associated) transaction card number and EAIN.

Debit servicer 521 communicates with processor 533, which optionally retrieves information from the cardholder information table in order to verify the validity of the transaction card account, the expense account, and/or the requested transaction. The transaction card number acts as an index into this table to support the retrieval. If the debit servicer 521 does not determine that the accounts or request are invalid, then it communicates with processor 533, which retrieves information from the lookup table 535. EAIN may act as an index into this table to support this lookup.

If the lookup fails to retrieve a record, then the debit servicer 521 is informed that the request is to be denied, and the processor 533 optionally updates the transaction record table to record the status of the transaction request. Primary authorization is thus rejected. If the lookup retrieves a record, but the status of the associated account is identified as invalid, then the debit servicer 521 is informed that the request is to be denied, and the processor optionally updates the transaction record table to record the status of the transaction request. Primary authorization is thus rejected. If the lookup retrieves a valid record, the processor 533 inspects the associated transaction account number and other information retrieved from the lookup table 535 and determines how the transaction is to be routed.

If processor 533 identifies the transaction request as being serviced by an internal transaction processor 505, then some or all of the information contained in the request is forwarded to an internal transaction processor 505, along with some or all of the information from the retrieved lookup table 535 record. This information generally includes the amount of the requested transaction, the associated transaction card account number and EAIN, and identification of at least one of the actual SE card reader or the debit servicer 521. It may also include an EAIN and other information that identifies the transaction, SE, and/or cardholder.

The internal transaction processor 505 services the requested transaction in the same manner as if the transaction were received by a credit servicer, charge servicer, or debit servicer, in the manner of a conventional credit, charge, or debit institution. As such, it uses the account number, EAIN, and other identifying information such as expiration date, name, address, and the like, to initially validate the request. The internal transaction processor then proceeds with any fraud, credit, and/or financial checks that may include any or all of the following: (a) that the request will not result in an overdrawn account, (b) that the request will not exceed the line of credit, (c) that the request will not trigger fraud rules, and/or (d) that the request will not trigger other transaction precluding credit rules. After meeting these and any other conditions, including system availability, the requested transaction is accepted.

In the non-limiting embodiment illustrated in FIG. 5, internal transaction processing for all types of transaction accounts proceed along one of two exemplary processing routes. In one embodiment, the desired transaction is communicated from the service establishment card reader to the transaction card transaction processor 503. The transaction card transaction processor 503 handles this request as a direct transaction, as long as the underlying transaction account is accepted as payment by the service establishment. For example, although a transaction may be initiated as a debit card transaction against the transaction card provider 501, it may actually be executed as a charge card transaction with the service establishment as long as the merchant accepts the specific charge card. If the service establishment accepts the requested transaction account and there are no other rules precluding a direct transaction, then the transaction can be handled by using the same processing and infrastructure as for a native transaction initiated by the underlying card on a conventional POS device. Although the transaction is initiated as a transaction card transaction, the transaction card provider 501 in this instance is also the institution that owns the account, and once the request is received, the request can be processed as though it was initiated by the associated account and not the transaction card account. Optional additional details may be stored and/or printed in order for the merchant and cardholder to reconcile the different account numbers corresponding to the same transaction. Additional transaction details may optionally reflect the transaction as processed as a transaction card transaction on the card reader. For example, the transaction record may bear two transaction IDs, one for the debit card communication and the other for the native transaction. “Native,” as that term is generally used herein, is any transaction request that can be serviced by the transaction card provider 501 without generating a new transaction request that is sent to a different institution, which facilitates the processing of associated account information. In an exemplary embodiment, it is generally understood that native transactions are typically serviced internally, whereas non-native transactions are typically serviced externally.

If the internal transaction fails to meet the conditions to be processed as a native transaction, then the requested transaction is processed as a sequence of two transactions, that is, as a two-step transaction. The first step is a conventional debit transaction accommodated by the card processing network 513. In an exemplary embodiment, this step occurs with corresponding real-time exchange of funds between the financial institution of the transaction card provider and the financial institution of the service establishment. The second step is accommodated by an appropriate internal transaction processor 505. The transaction involves debit, charge, credit, stored value, or other processing, and will proceed in the conventional fashion. Additional transaction details may optionally reflect the fact that the transaction was processed as a transaction card transaction on the card reader. For example, the transaction record may bear two transaction IDs, one for the debit card communication and the other for the native transaction.

If processor 533 identifies the transaction request as being serviced by an external credit or charge card institution, then, depending on particular financial institution and/or service establishment requirements, some or all of the information contained in the request is forwarded to payment gateway 537, along with some or all of the information from the retrieved lookup table 535 record. This information generally includes the amount of the requested transaction, the associated transaction account number, and may include identification of the actual service establishment card reader, the debit servicer 521, and/or the payment gateway 537. This information will also typically include an EAIN enterred by the cardholder, and other information that identifies the transaction, SE, and/or cardholder. If available, a reference code may also be included. In this type of processing, one of two exemplary routes accommodate the requested transactions. With no or little change to existing card institutions, the processing is handled as a two-step transaction. Alternatively, however, financial institutions may configure their systems in order to handle transaction card transactions as native transactions. The next process step in handling external transaction requests is to determine if the requested financial institution has an arrangement to accommodate transaction card transactions. If so, then the transaction is handled as a native external transaction.

If processor 533 determines that the external request is to be handled as a two-step transaction, then either the debit gateway 539 or payment gateway 537 are used to initiate the second transaction. Additional transaction details may optionally reflect the fact that the transaction was processed as a transaction card transaction on the card reader.

If processor 533 determines that the external request is to be handled as native, then the transaction information is forwarded to the appropriate financial institution through an appropriate communication mechanism (for example, through debit gateway 539 or payment gateway 537). If not, then any agreed upon and implemented business-to-business transactional system might communicate the desired second transaction request. As before, the forwarding of a transaction request generally includes the actual service establishment card reader or the debit servicer 521 in order to identify the service establishment, as well as the amount of the requested transaction and the associated account number. At this point, secondary authorization begins. Secondary authorization is when the financial institution for the associated financial instrument is sent the request for the transaction.

Regardless of whether the transaction is handled as native or two-step transaction or as an internal or external transaction, the servicing system will return at minimum a status to reflect the success of the transaction. It may also return a transaction ID. This information is received by processor 533 from the originating system, which may be an internal transaction processor 505, a debit gateway 539, a payment gateway 537, or other such system, depending on the mechanism for transaction processing.

Processor 533 processes the transaction ID, status, and other information and formats a transaction response to return to the SE. This response may include identifying information about the underlying card institution and second transaction. It may include a transaction ID for the card processing network 513, and may also include a transaction ID for the underlying transaction. The final response, the secondary authorization, is sent from debit servicer 521 back to the card processing network 513, which then formats the primary authorization response to send back to the card reader.

Whenever a transaction is authorized, it is stored in the reconciliation table 541, which allows subsequent settlement to match authorization requests to settlement records. Since authorization only determines whether a charge will be allowed, but settlement actually effects the exchange of money in most cases, information must be stored in the reconciliation table 541, and includes, at minimum, the transaction card number, merchant ID, date, time, amount of charge, information such as card number to identify the associated payment instrument, EAIN, reference code, and possibly transaction IDs and other such information.

At the service establishment, the card reader will inform the service establishment and/or attached POS device (such as a cash register) that the transaction was successful, and that the purchase of goods and/or services should be completed. A receipt is optionally printed for the cardholder. The receipt may optionally be printed with a signature request, in which case a signed copy will be retained by the service establishment and a cardholder copy, unsigned, will be provided to the cardholder. If the signature request is included, the card reader or attached POS device may optionally prompt for a signature using a visual or other display. The service establishment may confirm receipt of signed copy before the final sale completes.

When the primary authorization information is returned to the merchant, it is stored in a settlement table in a POS device and/or attached systems for subsequent settlement that is typically used for actual clearance of charges for payment to the merchant by various card institutions. This primary authorization information consists of settlement records. In a typical embodiment, one settlement record exists for each authorized transaction. Alternative embodiments may store records differently, and may also include records for non-authorized transactions. Primary authorization information may also be printed and/or stored in other media.

The system for processing transactions for payment and billing is referred to as “settlement”. At periodic intervals, typically at the conclusion of the service establishment business day, the SE initiates settlement, wherein settlement records are sent to the appropriate financial institution for payment (and in some cases credit) to merchant accounts. Settlement records can be sent using a plethora of mechanisms such as electronic submission over any computer network or by mail. The mechanism typically includes encryption and optionally other security such as digital signatures. If a settlement record contains information about the associated payment instrument, then that settlement record can be sent directly to the associated financial institution. When the settlement record contains only information about the transaction card instrument, then the settlement record is submitted to the transaction card institution.

When a settlement record is sent directly to the associated institution, then that institution can use its prearranged mechanism for performing financial adjustments that total to an amount equal to the sum of all transactions that are reconciled within the batch of settlement records that it receives. This may be by a direct payment to the SE, through a bank account, or other mechanism. Reconciliation is described below.

When a settlement record is sent to a transaction card institution, then the transaction card institution performs a secondary settlement to ensure that transactions are directed to the appropriate card institutions. This may occur in any of several ways. If the original transaction was native, then this can be performed internally. Otherwise, the settlement must be directed to an external card institution. If the transaction card and external card institutions have a preexisting arrangement, then one mechanism for processing is to select settlement records that are for such an external card institution and forward directly to the external card institution for processing. Under this mechanism, the external institution can then perform direct settlement with the SE. Financial reports would be maintained and distributed by some combination of transaction card and external card institution to track the submission and/or processing of these secondary direct settlement records to the external card institution. Processing of native transactions would occur by a similar mechanism, the only difference being the fact that the associated financial institution is really part of the same institution as the transaction card institution.

Under some circumstances, for example when there is no prior arrangement between a transaction card and an external card institution, then secondary indirect settlement is performed. In this type of processing, two financial exchanges occur. Particularly, the transaction card institution submits a set of secondary settlement records to the external card institution, the secondary settlement. These are processed in the conventional manner as though the transaction card is a service establishment, resulting in payment from the external card institution to the transaction card institution. The transaction card institution also processes the primary settlement records and submits payment to the service establishment as the primary settlement. This two stage settlement is referred to as indirect settlement.

Regardless of the type of settlement that occurs, in an exemplary embodiment, the processing institution (transaction card and/or external card institution) will perform reconciliation in order to match authorization requests to settlement records. Any or all of the information stored in the reconciliation table 541, or similar data store within the external card institution. For example, this may be stored in a financial capture system. A matching algorithm is applied to correlate each settlement record to exactly one approved authorization request. The mechanism for establishing a match may vary depending on the various types of systems and institutions involved. For example, when a reference code or other transaction ID is available in both the settlement record and authorization request, then a match can easily be identified. If no such ID is available, then some combination of other information would be used such as date, time, amount, SE, transaction card number, and/or EAIN number. In typical processing, payments in the direct, primary indirect, and secondary indirect reconciliation will occur only after reconciliation is successful. Exception processing may be necessary to process irreconcilable records.

Preferably, the systems described herein have the capability to handle exceptions to the above-described processing. These exceptions include situations involving, for example, irreconcilable records and disputes. In such processing, automated or manual process steps may be desired to identify authorization requests and/or settlement records. Cardholder disputes may originate, in which case the card institution would need to provide information about the transaction card transaction. For example, a cardholder billing statement might only show “transaction card” or similar for the merchant, in which case the transaction card institution might need to generate explanations of charges or initiate disputes to the merchant. The conventional systems and processes would apply here, with the exception that there may be two steps required. For example, an indirect billing dispute would consist of the primary dispute from cardholder to external card institution and then a secondary billing dispute from external card institution to transaction card institution. As such, the transaction card institution would retrieve information that it has stored about the transaction, such as, for example, the authorization request, and may correspond with the SE.

Exception handling may also process cases where transaction card to other card associations may have been changed. This can be done by tracking changes in associations within the lookup table 535 and keeping date time information for all records.

Transaction card users may optionally be provided with statements reflecting transaction card usage periodically or by request. If so, the processor 533 of the transaction card provider, or other system that can access the transactional data from transaction card transactions, will select all transaction records that utilized the account and/or card of the cardholder for whom a statement is being generated.

Selected records will be appropriately formatted and provided to the transaction card user by a suitable mechanism such as printing and mailing, on-line statement access, touch tone response, or to an internal cardholder service representative by some sort of console, whereby the cardholder can contact the cardholder service representative by phone or other means in order to obtain statement information.

Similarly, statements may also be provided to card institutions, SEs, entities involved with the use and operation of payment gateway 537 or debit gateway 539, card processing network 515, and/or card processing network 513. These statements may be generated in a similar fashion, although record selection would be based on criteria such as the identity of the card institution, SE, payment gateway 537 or debit gateway 539, card processing network 515, and/or card processing network 513.

In another embodiment of the present invention, the system and method enables a consumer to use a PIN, biometric, merchant code and/or other indicia to conveniently instruct a financial institution to activate or utilize specific financial services or accounts (e.g. expense accounts) during a particular time period or during a particular transaction. The PIN (which as used herein may include a cardholder identification number, biometric, merchant code and/or other indicia discussed herein) may be inputted at the POS device and transmitted to a transaction card provider 501 similar to the embodiments discussed above for the transaction card number and/or EAIN. The transaction card transaction processor 533, internal transaction processor 505, or any other suitable component may also accept or translate the submitted PIN, biometric, merchant code and/or other indicia to derive, access or implement certain financial services. For example, when making a purchase, the cardholder may enter account information into a remote terminal such as a POS device, after which the cardholder inputs a particular PIN or biometric which is communicated to the transaction card processor 501. The transaction card transaction processor 533 may receive the PIN number, use the PIN number in a look-up table to determine a corresponding instruction or rule and transmit the instruction or rule to a person, financial institution, processor, issuer, emergency service and/or any other entity, as appropriate.

One skilled in the art will appreciate that, in various embodiments described herein, the cardholder may utilize a PIN, biometric, merchant code and/or other indicia in addition to, or in place of, the use of a transaction card number and/or EAIN number. The cardholder may also use a PIN, biometric, merchant code or other indicia to access or derive a transaction card number and/or EAIN number. Similarly, the cardholder may use a transaction card number and/or EAIN number to access or derive a PIN, biometric, merchant code or other indicia.

Furthermore, different biometric samples may be used to access different services. For example, a left thumb print may indicate a desire to charge the transaction to a particular charge card or EAIN, while a right thumb print indicates a desire to charge the transaction to a different transaction card or EAIN.

The financial services may include, for example, selecting a particular account or transaction card, payment instructions, notification instructions, security notifications, specific merchant rules, merchant category rules, geographic rules, expenditure rules or limits, and time or transaction limitations. The PIN may also be used to implement other limitations or restrictions on account usage such as, for example, authorized transactions, authorized goods or services, authorized vendors, stores, and service providers, transaction amount limitation, daily spending limit, authorized geographical area of usage, authorized time of usage, authorized transaction limit for an account, transaction card or automated teller machine account, authorized individual for transacting on an account, one or more banks or financial institutions authorized for the transaction, a limitation of a fee charge on an account, authorized transaction location, and/or authorized number of transactions. The financial services may also include authorization related to an account.

In addition to assigning expenses to an expense account, the use of a particular EAIN may have other consequences. For example, use of a particular EAIN may also instruct the system to charge all or any portion of the transaction to a first transaction card for transactions below $100, but to charge all or another portion of the transaction to a second transaction card for transactions greater than $100. A particular EAIN may also expire or change rules or limitations after a certain time period. The time period may be random, periodic (e.g., only certain fiscal quarters), set by the cardholder, set by the merchant, set by the issuer or set by the transaction card system. For example, EAIN 02 may only be valid for up to $500, but becomes invalid in five days. The merchant information may also modify the transaction. For example, EAIN 01 may instruct the system to charge all or any portion of the transaction to a first transaction card (e.g., personal card) for transactions at a grocery store, but all or another portion of the transaction to a second transaction card (e.g., corporate card) for transactions with an airline.

Location information related to the merchant (e.g., within the merchant code), in addition to the PIN, may also modify the transaction. For example, EAIN 01 may instruct the system to assign all or any portion of the transaction to a first expense account (e.g., client entertainment), but all or another portion of a transaction to a second expense account. In this embodiment, the system analyzes the EAIN and merchant code information before determining the appropriate action. For example, EAIN 05 may instruct the system to search for the merchant code to determine the location information.

A system and methodology have been provided herein which segregate business and personal expenses, and/or tax deductible and non-tax deductible expenditures, which are charged to a credit or debit card. The system and method have been described herein in considerable detail in order to comply with the patent Statutes and to provide those skilled in the art with the information needed to apply the novel principles and to construct and use such specialized components as are required. However, it is to be understood that various modifications to the details of the system and method can be accomplished without departing from the scope of the teachings herein.

What is claimed is:

1. A business arrangement, comprising:
a first business entity having a transaction card associated therewith that the first business entity manages;
a second business entity; and
a contract between the first and second business entities; whereby, under the terms of the contract, (a) the first business entity agrees to issue transaction cards to the second business entity and to manage the cards, (b) the second business entity agrees to pay the expenses incurred against the cards and to pay a management fee to the first entity, and (c) the second business entity further agrees that the cards shall be used solely for tax deductible business expenses.

2. The business arrangement of claim 1, further comprising a third business entity which provides financial services to the second business entity, wherein the third business entity has software associated therewith that (a) accesses digital receipts resulting from use of the transaction cards, and (b) utilizes information from those receipts to prepare financial documents for the second business entity.

3. The business arrangement of claim 2, wherein the software accesses the digital receipts from a server associated with the first business entity.

4. A method for doing business, comprising the steps of:
providing a first business entity having a transaction card associated therewith that the first business entity manages; and
executing a contract between the first business entity and a second business entity; whereby, under the terms of the contract, (a) the first business entity agrees to issue transaction cards to the second business entity and to manage the cards, (b) the second business entity agrees to pay the expenses incurred against the cards and to pay a management fee to the first entity, and (c) the second business entity further agrees that the cards shall be used solely for tax deductible business expenses.

5. The method of claim 4, wherein the contract further specifies that the second business entity shall use the card only for non-capital expenses.

6. A method for categorizing expenses charged against a transaction card, comprising the steps of:
utilizing a transaction card to make a purchase at a Point of Sale (POS); and
entering an expense code at the POS which identifies a tax category that the expense is associated with.

7. The method of claim 6, further including the step of entering a personal identification number (PIN), and wherein the expense code is entered after the PIN is entered.

8. The method of claim 7, wherein the PIN is a four-digit number, and wherein the expense code is a two-digit number.

9. The method of claim 6, wherein the expense code is entered by the party making the purchase.

10. The method of claim 9, wherein a terminal is utilized to process the transaction card, and wherein the expense code is entered at the terminal.

11. The method of claim 9, wherein a first terminal is utilized to process the transaction card, and wherein the expense code is entered at a second terminal which is in communication with the first terminal.

12. The method of claim 6, wherein the expense code is numeric.

13. A system for processing a transaction card, comprising:
a transaction card associated with a cardholder;
a plurality of terminals, each of said terminals being adapted to process a sale utilizing the transaction card, and being further adapted to allow the cardholder to enter an expense code associated with the sale, said expense code identifying a tax category that the expense is associated with.

14. The system of claim 13, wherein said terminal is adapted to query the user for the expense code.

15. The system of claim 13, wherein each of said terminals is further adapted to query the cardholder for a personal identification number (PIN).

16. The system of claim 15, wherein each of said terminals is adapted to query the cardholder for a PIN prior to querying the cardholder for an expense code.

17. The system of claim 13, wherein each of said terminals is adapted to query the cardholder for a code at the time of sale, wherein a first portion of the code is a PIN, and wherein a second portion of the code is the expense code.

18. The system of claim 15, wherein the PIN is a four-digit number, and wherein the expense code is a two-digit number.

19. The system of claim 13, further comprising a keypad in communication with the terminal, said keypad being adapted to allow a cardholder to enter an expense code.

20. The system of claim 13, wherein a first terminal is utilized to process the transaction card, and wherein the expense code is entered at a second terminal which is in communication with the first terminal.

21. The system of claim 13, wherein the expense code is numeric.

22. A method for categorizing expenses charged against an account, comprising the steps of:
receiving, from a purchaser, account information identifying an account against which the expense of goods or services being purchased is to be debited; and
receiving, from the purchaser, an expense code which identifies a tax category that the expense is associated with.

23. The method of claim 22, wherein the expense code is received at the Point of Sale (POS).

24. The method of claim 22, wherein the account information is received from the purchaser through the use of a transaction card.

25. A method for associating a transaction card transaction with an expense account, comprising the steps of:
receiving transaction request information from a cardholder via a remote terminal, wherein said request includes a number associated with an expense account in addition to account authorization; and
processing said transaction request information and number to associate the transaction with the expense account.

26. The method of claim 25, further comprising the steps of:
receiving transaction request information from a cardholder via a remote terminal, wherein said request comprises a cardholder card number and an expense account identification number; and
processing said card number and said expense account identification number to determine which cardholder expense account is associated with the transaction.

27. The method of claim 25, wherein said step of receiving transaction request information from a cardholder via a remote terminal, wherein said request includes a PIN including at least one of a cardholder identification, biometric, and merchant code.
